(19) United States
(12) Patent Application Publication
(10) Pub. No.: US 2005/0086601 A1
(43) Pub. Date: Apr. 21, 2005

(54) Portable file-playing control device and file storing and playing method

(76) Inventors: John C. Wang, Taipei (TW); Mu-Yi Chen, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/887,078

(22) Filed: Jul. 8, 2004

(30) Foreign Application Priority Data
Oct. 21, 2003 (TW) 092129204

(51) Int. Cl. G06F 3/00; G11B 27/00

(52) U.S. Cl. 715/716; 715/719; 715/720; 715/727; 715/817; 715/818; 715/819; 715/820; 715/840; 715/810

(57) ABSTRACT

A portable file-playing control device includes a housing; an input connector common to data input and power input, disposed in and partially exposed from the housing for coupling to a data source in a data-input state and coupling to a power source in a data-output state; a memory disposed in the housing for storing therein data received from the data source via the input connector; and an output connector disposed in and partially exposed from the housing for coupling to a playing apparatus in the data-output state. By storing a plurality of file folders in the portable file-playing control device, one of the file folders can be selected via a command interface to be played by the playing apparatus when the portable file-playing control device is made to communicate with the playing apparatus.

### FIELD OF THE INVENTION

The present invention relates to a portable file-playing control device and method, and more particularly to a portable computer-file playing control device and method allowing data of a computer to be played by a playing apparatus.

### BACKGROUND OF THE INVENTION

Conventionally, for presentation purpose, a notebook computer was used to show the data stored therein via a playing apparatus such as a projector. In most cases, the data are just played rather than edited in situ. Therefore, hardly complicated program is required to be executed by the computer, so it is effort-inefficient to carry a cumbersome notebook computer with the speaker for just displaying the stored data. For alleviating the speaker's burden while achieving the similar purpose, a portable computer-file playing control device was developed to previously download data from the computer at a first place and then have the data to be displayed via the playing apparatus at a second place. A schematic functional block of a conventional portable computer-file playing control device is shown in FIGS. 1A and 1B, wherein FIG. 1A illustrates the control device in a data download procedure and FIG. 1B illustrates the control device in a data playing procedure.

Please refer to FIG. 1A. The portable computer-file playing control device 1 includes a USB socket 21 to communicate with a computer 10 via a USB transmission line 12. The data required to be displayed for presentation are first converted from the originally edited program files, e.g. in MICROSOFT® POWERPOINT® format, into a plurality of image files, e.g. in JPEG format, and then transmitted to the portable computer-file playing control device 1 to be stored in a nonvolatile memory 11. The nonvolatile memory, for example, can be a NAND-type flash memory, SD memory card or MS memory card, etc. Meanwhile, the electric power required for the portable computer-file playing control device 1 to transmit and save the image files is supplied via the electric cord incorporated in the USB transmission line 12. After the data have been successfully downloaded, the USB socket 21 is detached from the computer 10 and the control device becomes portable again.

When the presentation is to be performed, a data output socket 22 of the portable computer-file playing control device 1 is made in communicate with the playing apparatus 14 via an image-output line 13, as shown in FIG. 1B. The playing apparatus 14, for example, can be a projector, television or computer display, and the image-output line 13, for example, can be a composite video or s-video output line. Preferably, the portable computer-file playing control device 1 further includes a remote controller 15 having a forward button 16 and a backward button 17 optionally actuated for selecting one of the image files to be played. Generally, the image-output line 13 just transmits image files to the playing apparatus 14 other than simultaneously transmits the electric power. Therefore, a battery box 18 or a power supply 20 is required to provide electric power for the portable computer-file playing control device 1. When the battery box 18 is used, the battery box 18 is coupled to the portable computer-file playing control device 1 via a battery socket 23. On the contrary, if it is the power supply 20 selected, the portable computer-file playing control device 1 is electrically connected to the power supply 20 via a power socket 24 and a power cable 19.

While playing, the image files stored in the nonvolatile memory 11 are sequentially outputted to the playing apparatus 14. Therefore, in spite the image files can be selectively played by operating the buttons 16 and 17 of the remote controller 15 as mentioned above, no non-selected image files between a first selected file and a second selected file can be exempted from being played. For example, as shown in FIG. 2, the first and fourth frames F1 and F4 are the ones to be referred to for certain description during the presentation, the speaker can click the forward button 16 of the remote controller 15 to show the first frame F1, and then click the forward button 16 trice to skip the second and third frames F2 and F3 so as to show the fourth frame F4. Likewise, when the backward button 17 is used to play the fourth frame F4 and then the first frame F1, the backward button 17 still has to be clicked trice to skip the non-selected second and third frames F2 and F3. Once the image files are in great number and the frames to be selected are far away from each other, the operation will become complicated and inefficient. Further, it is difficult for the speaker to locate the desired frames

Since the conventional portable computer-file playing control device 1 includes many sockets for power cord connection, battery box connection, image input and image output, respectively, the manufacturing process and cost will be inefficient. Aside from, the socket identification and connection operation are not user-friendly.

Further, because of different aspect ratios and resolutions occurring between frames of the computer system where the image files are inputted and the playing device where the image files are outputted, the frames shown by the playing device might be partially cut off.

### SUMMARY OF THE INVENTION

Therefore, the present invention provides a portable computer-file playing control device having a reduced count of sockets.

The present invention also provides a portable computer-file playing control device, which processes the frame specification of the image files into that suitable for the playing apparatus.

The present invention further provides a computer-file storing and playing method for easily locating the desired frames.

According to a first aspect of the present invention, a portable file-playing control device comprises a housing; an input connector common to data input and power input, disposed in and partially exposed from the housing for coupling to a data source in a data-input state and coupling to a power source in a data-output state; a memory disposed in the housing for storing therein data received from the data source via the input connector; and an output connector disposed in and partially exposed from the housing for coupling to a playing apparatus in the data-output state.

Preferably, the portable file-playing control device further comprises a command interface manipulated to have the data in the memory played by the playing apparatus in a designated sequence.

In an embodiment, the data stored in the memory includes a plurality of file folders, which are browsed via the playing apparatus by manipulating forward and/or backward buttons of the command interface, and freely selected to be played by the playing apparatus by actuating a selection button of the command interface.

Preferably, the command interface is a remote controller.

In an embodiment, the portable file-playing control device further comprises a data transmission line for coupling the input connector to the data source and a power transmission line for coupling the input connector to the power source. Preferably, the same transmission line is used as the signal transmission line in the data-input state and used as the power transmission line in the data-output state. The input connector asserts a response-requesting signal when coupled to the transmission line, and the data-output state is determined if the input connector receives no response correspondingly in a predetermined period.

In an embodiment, the input connector is a USB-compatible connector and includes two signal pins and two power pins. The two signal pins are floating in the data-output state.

Alternatively, the input connector is a USB-compatible or an IEEE 1394-compatible connector.

For example, the power source can be a battery box or an alternate-to-direct current voltage converter.

Preferably, the memory is a nonvolatile memory.

In an embodiment, the portable file-playing control device is built therein a format conversion device for scaling down and framing the graphic-file data received from the data source in the data-output state.

A second aspect of the present invention relates to a file storing and playing method. The method comprises steps of storing a plurality of file folders in a portable file-playing control device; communicating the portable file-playing control device with a playing apparatus; and freely selecting one of the file folders to be played by the playing apparatus via a command interface.

Preferably, the file storing and playing method further comprises a step of previewing the file folders before making selection.

In an embodiment, the file folders are previewed as a list of the plurality of file folders, and freely selected to be played through the list by manipulating the command interface. If each of the file folders is built to include a plurality of framed graphic files by a computer system and stored into the portable file-playing control device, the file folders can be previewed as a thumbnail containing index graphic files of the file folders with reduced sizes.

In an embodiment, if the selected file folder consists of a plurality of data files, the plurality of data files are played in sequence via the forward button or the backward button of the command interface.

Preferably, the file storing and playing method further comprises a step of indicating end of data files in the selected file folder.

In an embodiment, the file storing and playing method further comprises a step of playing the first data file of another file folder next to the selected file folder by actuating the forward button when the last data file of the selected file folder is being played.

In an embodiment, the file storing and playing method further comprises a step of displaying the thumbnail for the user to make further selection among the file folders by actuating the backward button when the first data file of the selected file folder is being played.

Preferably, each of the file folders is built to include a plurality of data files by a computer system and stored into a memory of the portable file-playing control device in a manner that all of the data files start at different sectors of the memory. More preferably, adjacent two of the data files are stored in the memory optionally with filling bytes therebetween so that the starting byte of the latter one of the two data files is stored at the starting position of a specified sector.

According to a third aspect of the present invention, a file storing and playing method comprises steps of: storing a plurality of data files in a memory of a portable file-playing control device in a manner that starting bytes of the data files are respectively stored at starting positions of different sectors of the memory; and communicating the portable file-playing control device with a playing apparatus to have the data files played by the playing apparatus.

When the plurality of data files are data blocks included in a file folder, the file folder preferably further includes a file header ahead of the data blocks.

Preferably, filling bytes are optionally provided between the file header and one of the data blocks next to the file header.

Preferably, the file header includes a plurality of indices and optional filling bytes between adjacent two of the indices so that starting bytes of the indices are stored at starting positions of storage units of the memory.

Preferably, filling bytes are optionally provided between adjacent two of the data files.

### BRIEF DESCRIPTION OF THE DRAWINGS

The present invention will become more readily apparent to those ordinarily skilled in the art after reviewing the following detailed description and accompanying drawings, in which:

FIG. 1A is a functional block diagram schematically illustrating a conventional control device in a data download procedure;

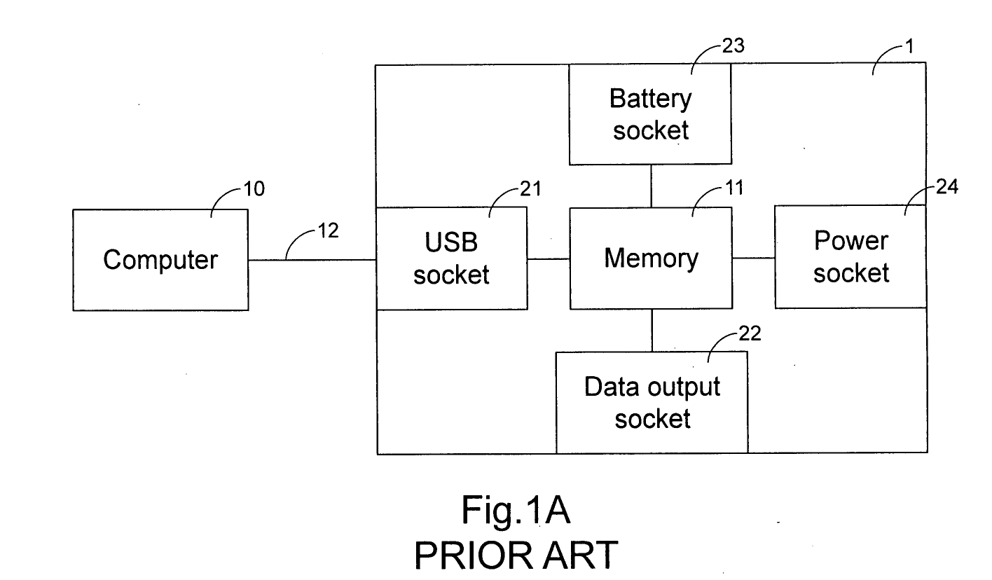

FIG. 1B is a functional block diagram schematically illustrating the control device of FIG. 1A in a data playing procedure;

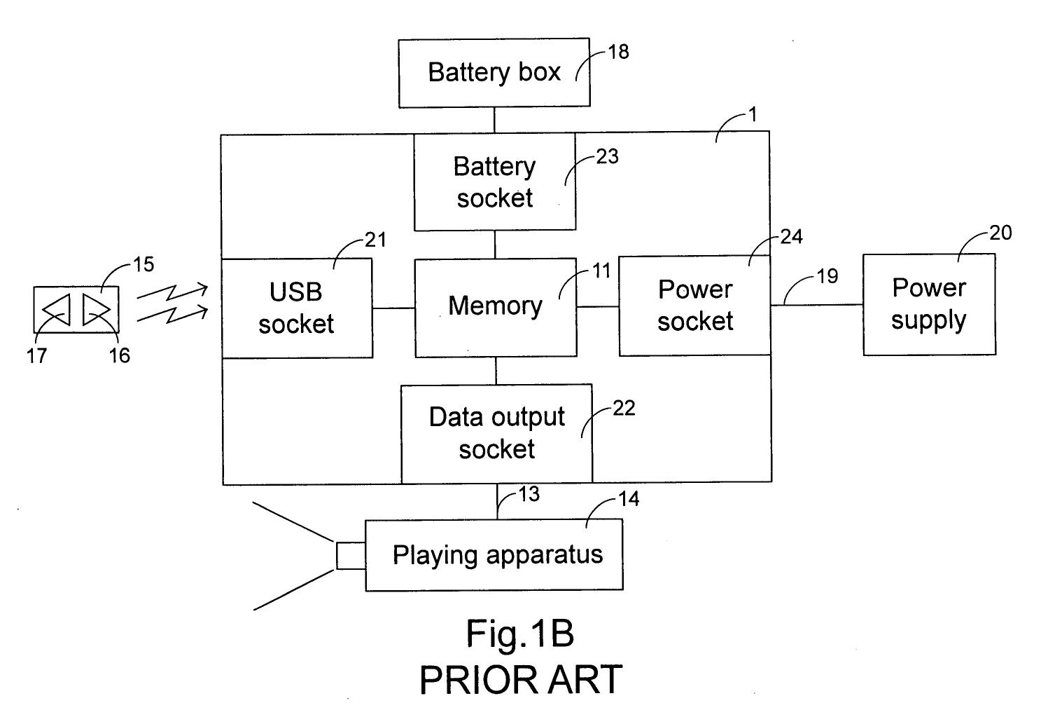

FIG. 2 is a schematic block diagram illustrating the conventional frame-switching method in response to the actuation of the command interface;

FIG. 3 is a functional block diagram schematically illustrating an embodiment of a portable file-playing control device according to the present invention;

FIG. 4A is a functional block diagram schematically illustrating the portable file-playing control device of FIG. 3 in a data-input state;

FIG. 4B is a functional block diagram schematically illustrating the portable file-playing control device of FIG. 3 in a data-output state;

FIG. 4C is a functional block diagram schematically illustrating the portable file-playing control device of FIG. 3 in another data-output state;

FIG. 5 is a table schematically illustrating the state changes of two signal pins D− and D+ and two power pins Vbus and GND when a standard USB transmission line is electrically connected to a battery box or an alternate-to-direct current voltage converter;

FIG. 6A is a schematic block diagram showing an example of the data stored as a plurality of file folders in the memory; and

FIG. 6B is a schematic block diagram showing the file-switching method in response to the actuation of the command interface according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

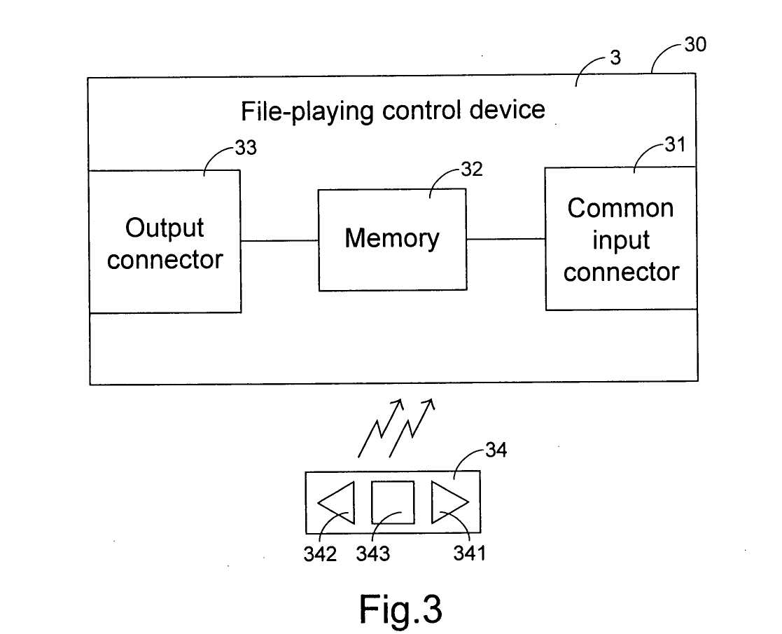

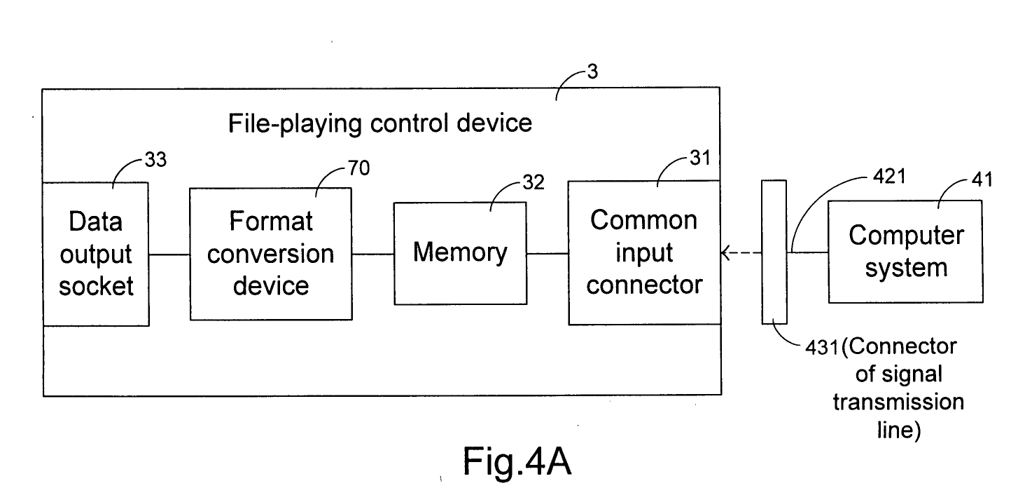

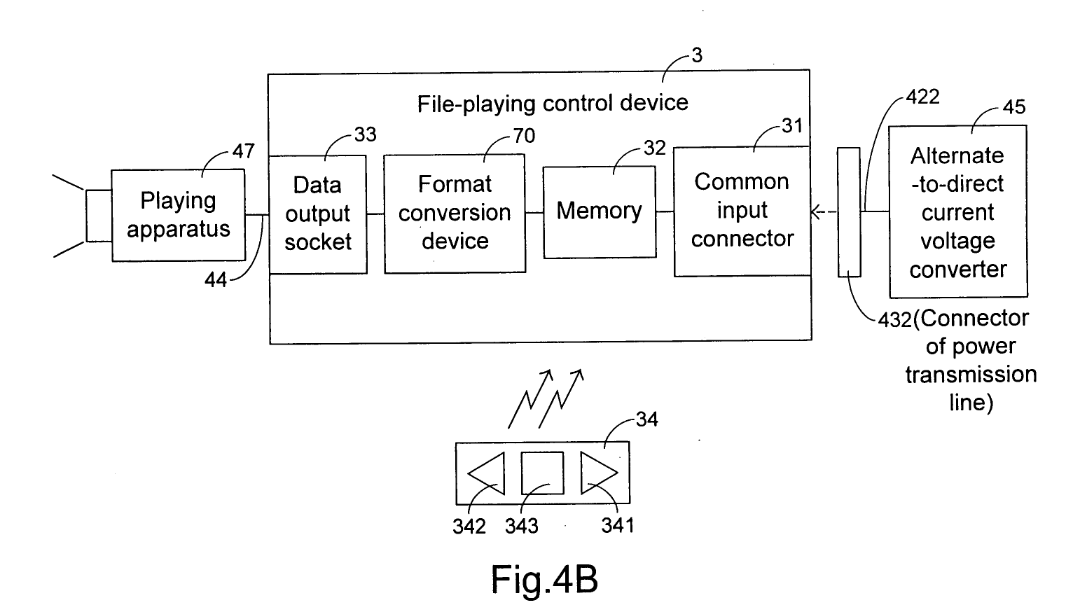

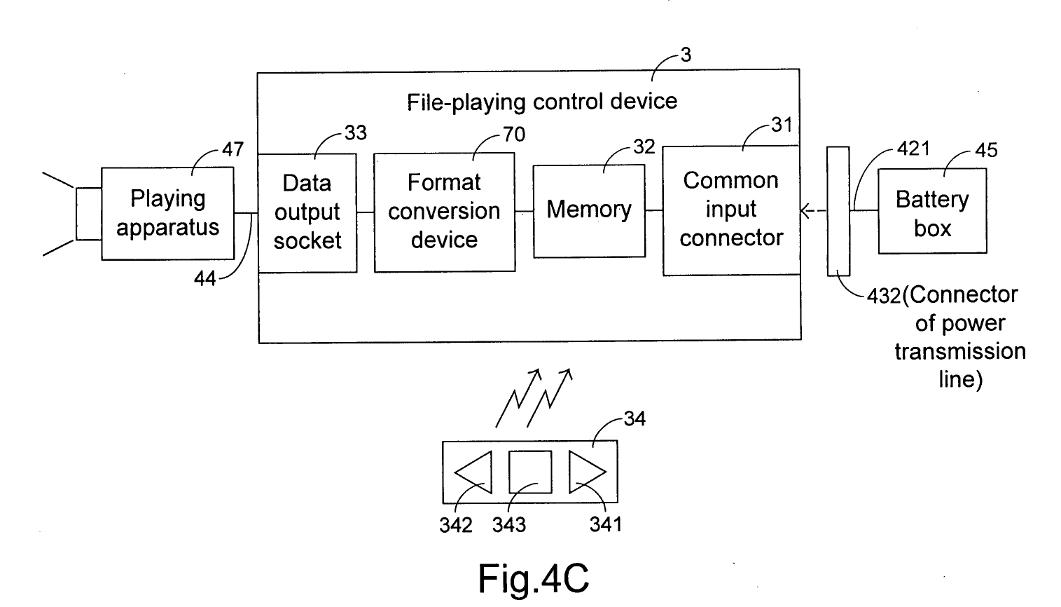

Please refer to FIG. 3. An embodiment of a portable file-playing control device 3 according to the present invention includes an input connector 31, a memory 32 and an output connector 33 disposed in a housing 30. The input connector 31 is disposed in and partially exposed from the housing 30 and common to data input and power input. In a data-input state, as shown in FIG. 4A, the input connector 31 is coupled to a data source, e.g. a computer system 41, via a data transmission line 431 to receive data from the data source. With the transference of data, power is simultaneously transmitted from the data source to the file-playing control device 3. The data received from the data source via the input connector 31 in the data-input state are stored in the memory 32. The memory is preferably a nonvolatile memory, and for example, can be a NAND-type flash memory, SD memory card or MS memory card, etc. On the other hand, in a data-output state, the input connector 31 is detached from the data source and the output connector 33 is coupled to a playing apparatus 47 via another signal transmission line 44, as shown in FIG. 4B or 4C. Since the power supply is interrupted with the detachment of the input connector 31 from the data source, it is necessary for the file-playing control device 3 to obtain power from a power source, e.g. an alternate-to-direct current voltage converter 45 as shown in FIG. 4B or a battery box 46 as shown in FIG. 4C, via a power transmission line 432. According to the present invention, the same input connector 31 previously serving as a data-input connector can be used herein as a power-input connector.

The input connector 31, for example, can be an USB-compatible connector. Accordingly, the data transmission line 421 and power transmission line 422 can be both USB transmission lines. The respective connectors 431 and 432 of the data and power transmission lines 421 and 422 are both engageable in shape and compatible in pin configuration with the input connector 31. Moreover, the same USB transmission line can be used as the data transmission line 421 in the data-input state and used as the power transmission line 422 in the data-output state. For sharing the transmission line in both states, the input connector asserts a response-requesting signal when coupled to the transmission line. If the input connector receives timely response from the opposite connector of the transmission line, it means that the transmission line is serving as a signal transmission line, and it is now in the data-input state. On the contrary, the transmission line being the power transmission line and the state being the data-output state are determined if the input connector receives no response correspondingly in a predetermined period.

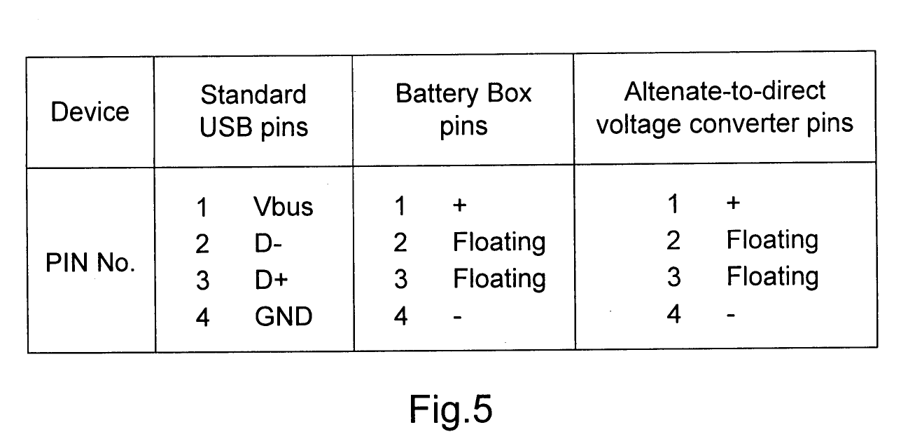

A standard USB transmission line includes two signal pins D− and D+ and two power pins Vbus and GND, as illustrated in FIG. 5. When the transmission line connects the input connector 31 to the computer system 41 for transmitting data, all the signal pins D− and D+ and power pins Vbus and GND are in an operational state. On the other hand, when the transmission line connects the input connector 31 to the alternate-to-direct current voltage converter 45 or battery box 46 for transmitting power, the signal pins (the 2^{nd} and 3^{rd} pins as shown) of the opposite connector of the transmission line to be coupled to the power source become floating. In addition to USB transmission mode, the communication between the input connector and the signal/power source can also be in IEEE 1394 transmission mode. In other words, the input connector 31 can be an IEEE1394-compatible connector and the data/power transmission line is an IEEE 1394 transmission line.

Please refer to FIGS. 4A˜4C again. In each of these embodiments, the file-playing control device 3 is built therein a format conversion device 70 between the memory 32 and the output connector 33. The data to be stored into the memory 32 of the file-playing control device 3 are first converted from the originally edited program files, e.g. in MICROSOFT® POWERPOINT® format, into a plurality of data files, e.g. image or graphic files in JPEG format, by the computer system 41. The image files, before being outputted from the memory 32 to the playing apparatus 47 via the output connector 33, are processed by the format conversion device 70. The format conversion device 70 works for scaling down and framing the image data so that the frame specification of the image files can be converted into that suitable to be played by the playing apparatus. Alternatively, the image data can be scaled down and framed before being transmitted from the data source to the portable file-playing control device. In this case, no format conversion device is required in the portable file-playing control device.

In addition to image files, the data can also be audio data files, video data files or any other digital files suitable to be played by the playing apparatus.

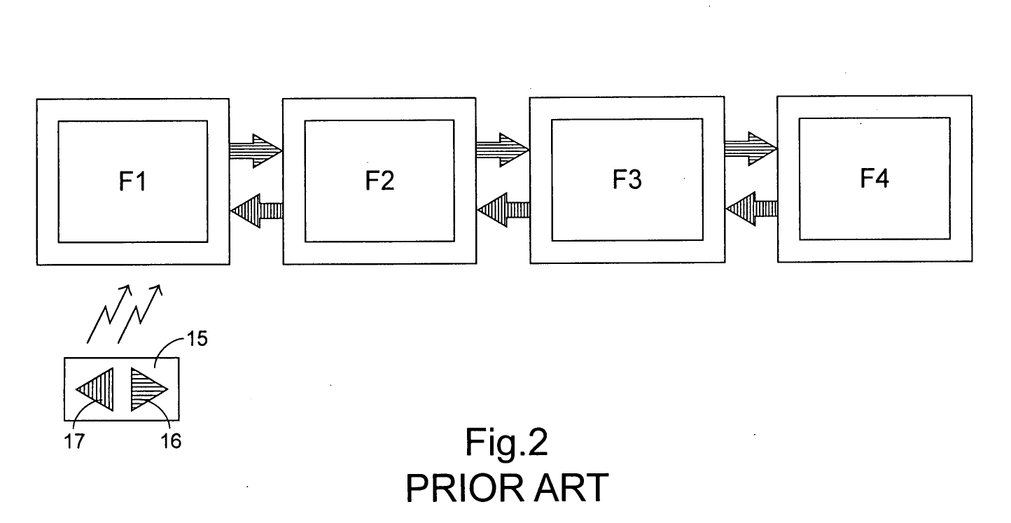

The file-playing control device 3 further include a command interface 34 to be manipulated by the user so that the data can be played by the playing apparatus in a designated sequence. The command interface, for example, can be a remote controller with a forward button 341, a backward button 342 and a selection button 343. While a following data file is played by pushing the forward button 341 once, a preceding data file is played by pushing the backward button 341 once. As exemplified in FIG. 2, tens of pushing operations of the buttons might be required if next data file to be played is far way from the previous data file or cannot be located accurately. Therefore, according to the present invention, the data are preferably stored in the memory 32 as a plurality of file folders so that the user can readily locate the desired data file from a selected folder while skipping the data files in the other folders. The file folders can be browsed via the playing apparatus by manipulating forward and/or backward buttons 341 and/or 342, and freely selected to be played by the playing apparatus by actuating the selection button 343.

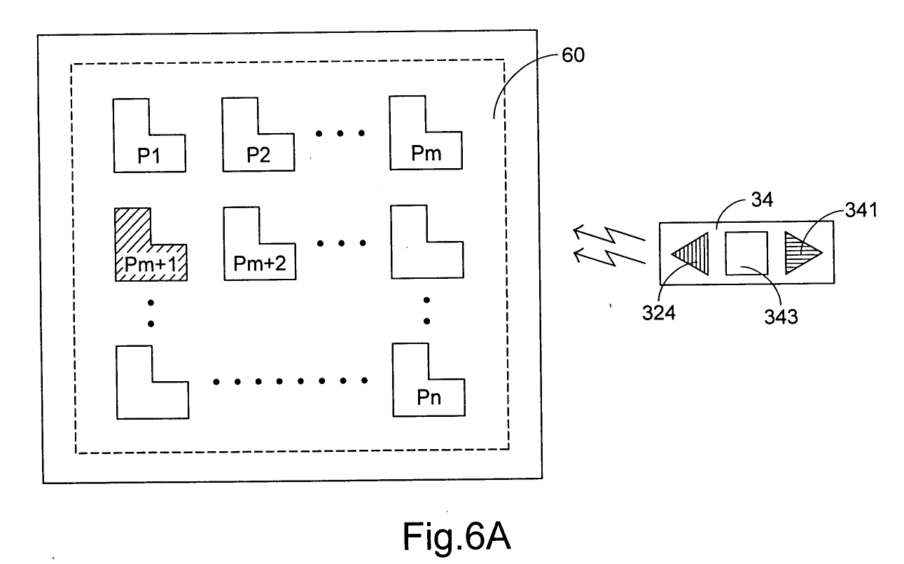

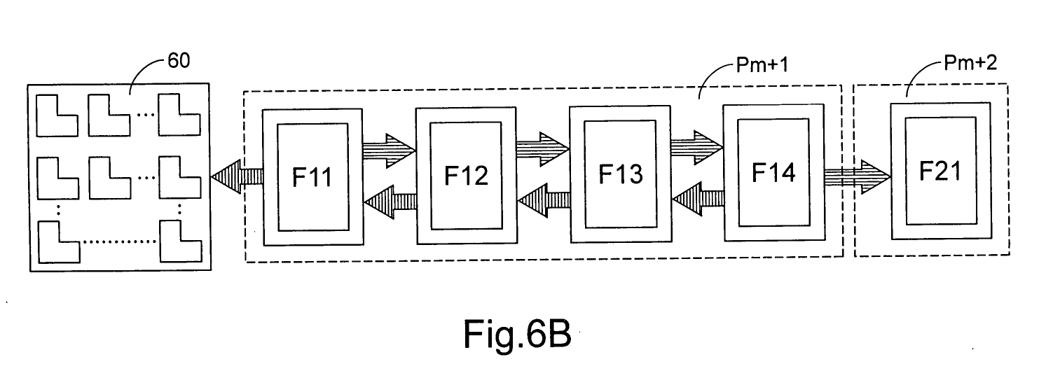

Hereinafter, how the desired data file is selected according to the present invention will be described with reference to FIGS. 6A and 6B. FIG. 6A schematically shows an example of the data stored as a plurality of file folders P1˜Pn in the memory, and FIG. 6B schematically shows an example of the file-switching sequence. First of all, the file folders P1˜Pn are listed in a manner visible to the user, e.g. shown on a display, so that the user can make his selection through the list 60. The list, for example, can consist of descriptions of the folders. Alternatively, for image file folders, the list 60 of file folders can be replaced by a thumbnail consisting of first frames respectively in the file folders. Assuming a data file F13 among the four data files F11˜F14 in the file folder Pm+1 is to be selected, the user should push the forward button 341 or the backward button 342 until the file folder pm+1 is reached, as shown in FIG. 6A. Meanwhile, the selection button 343 is pushed to enter the selection. Once the file folder Pm+1 is entered, the first data file F11 is first played. By pushing the forward button 341 twice, the third data file F13 can be played, as illustrated in FIG. 6B.

Following the data file F13, the user may want to select another data file in another file folder. In this case, what the user should do is to push the backward button 342 until the first data file F11 in the file folder Pm+1 is passed Then, the list 60 will be entered so that the user can make another selection as mentioned above. Alternatively, if it is the data file in the file folder Pm+2 next to the file folder Pm+1 to be selected, the user can just push the forward button 341 until the last data file F14 in the file folder Pm+1 is passed. Then, the first data file F21 in next file folder Pm+2 will be reached, and any of the data files in the file folder Pm+2 can be selected in a similar way to the above. For facilitating the operations of the user, it is preferred that a visible, audible or any other kind of prompt is given to indicate that the first or the last data file has been reached.

For recording necessary information, it is preferred that each file includes a file header of the data blocks included therein. For example, the file header contains information such as file header ID (4 bytes), version number of file header format (4 bytes), file header length (4 bytes), data block count (4 bytes), sub-header number (4 bytes), distance between the start of the file header and the first sub-header (4 bytes), contents of sub-headers (16 bytes for each). On the other hand, each of the sub-headers is used as an index and consists of sub-header ID (2 bytes), data block sequence number (2 bytes), sector number between the data block and file header (4 bytes), data block length (4 byte) and reserved bytes (4 bytes). Since the most effective access length of a general dynamic random access memory (DRAM) is 16 bytes, filling bytes are preferably provided before the first sub-header so that the starting byte of each of the first and the following sub-headers is located at the beginning of each 16-byte address section. In this way, the sub-headers can be readily and effectively accessed. Likewise, in order to quickly locate each single data block, the data blocks are preferably stored in the memory 32 in a manner that all data blocks start at different sectors of the file system over the memory and stored from starting positions of respective sectors. For achieving this purpose, filling bytes are optionally provided between the last sub-header and the first data block and between every adjacent two of the data blocks so that the starting byte of each single data block is stored at the starting position of a specified sector. Taking a general hard disc drive for an example, each sector includes an address space of 512 bytes.

It is apparent from the above description that the present invention provides a modified portable file-playing control device which has reduced count of connectors to simplify the structure. In addition, the portable file-playing control device according to the present invention is capable of playing image files with scaled down and framed features so as to prevent from the improper frame-cutting problem. By well arranging the data files in a systematic way, e.g. classifying the data files into file folders, and allowing the data files to be freely selected, the work such as presentation can proceed efficiently. Moreover, the special file storing and playing method of the present invention makes the access of the data files efficiently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A portable file-playing control device, comprising:
a housing;
an input connector common to data input and power input, disposed in and partially exposed from said housing for coupling to a data source in a data-input state and coupling to a power source in a data-output state;
a memory disposed in said housing for storing therein data received from the data source via said input connector; and
an output connector disposed in and partially exposed from said housing for coupling to a playing apparatus in said data-output state.

2. The portable file-playing control device according to claim 1 further comprising a command interface manipulated to have the data in said memory played by the playing apparatus in a designated sequence.

3. The portable file-playing control device according to claim 2 wherein the data stored in said memory includes a plurality of file folders, which are browsed via the playing apparatus by manipulating forward and/or backward buttons of said command interface, and freely selected to be played by the playing apparatus by actuating a selection button of said command interface.

4. The portable file-playing control device according to claim 2 wherein said command interface is a remote controller.

5. The portable file-playing control device according to claim 1 further comprising a data transmission line for coupling said input connector to the data source, and a power transmission line for coupling said input connector to the power source.

6. The portable file-playing control device according to claim 5 wherein said input connector is a USB-compatible connector and includes two signal pins and two power pins.

7. The portable file-playing control device according to claim 6 wherein said two signal pins are floating in said data-output state.

8. The portable file-playing control device according to claim 5 wherein a single transmission line is used as said signal transmission line in said data-input state and as said power transmission line in said data-output state.

9. The portable file-playing control device according to claim 8 wherein said input connector asserts a response-requesting signal when coupled to said single transmission line, and said data-output state is determined if said input connector receives no response correspondingly in a predetermined period.

10. The portable file-playing control device according to claim 1 wherein said input connector is a USB-compatible or an IEEE1394-compatible connector.

11. The portable file-playing control device according to claim 1 wherein said input connector is for coupling to a battery box or an alternate-to-direct current voltage converter in said data-output state.

12. The portable file-playing control device according to claim 1 wherein said memory is a nonvolatile memory.

13. The portable file-playing control device according to claim 1 further comprising a format conversion device for scaling down and framing the graphic-file data received from the data source in said data-output state.

14. A file storing and playing method, comprising steps of:
storing a plurality of file folders in a portable file-playing control device;
communicating said portable file-playing control device with a playing apparatus; and
freely selecting one of said file folders to be played by said playing apparatus via a command interface.

15. The file storing and playing method according to claim 14 further comprising a step of previewing said file folders before making selection.

16. The file storing and playing method according to claim 15 wherein said file folders are previewed as a list of said plurality of file folders, and freely selected to be played through said list by manipulating said command interface.

17. The file storing and playing method according to claim 14 wherein each of said file folders is built to include a plurality of framed graphic files by a computer system and stored into said portable file-playing control device.

18. The file storing and playing method according to claim 17 further comprising a step of previewing said file folders before making selection, wherein said file folders are previewed as a thumbnail containing index graphic files of said file folders with reduced sizes.

19. The file storing and playing method according to claim 14 wherein if said selected file folder consists of a plurality of data files, said plurality of data files are played in sequence via a forward button or a backward button of a command interface.

20. The file storing and playing method according to claim 19 further comprising a step of indicating end of data files in said selected file folder.

21. The file storing and playing method according to claim 19 further comprising a step of playing the first data file of another file folder next to said selected file folder by actuating said forward button when the last data file of said selected file folder is being played.

22. The file storing and playing method according to claim 19 further comprising a step of displaying said thumbnail for the user to make further selection among said file folders by actuating said backward button when the first data file of said selected file folder is being played.

23. The file storing and playing method according to claim 14 wherein each of said file folders is built to include a plurality of data files by a computer system and stored into a memory of said portable file-playing control device in a manner that all of said data files start at different sectors of said memory.

24. The file storing and playing method according to claim 23 wherein adjacent two of said data files are stored in said memory optionally with filling bytes therebetween so that the starting byte of the latter one of said two data files is stored at the starting position of a specified sector.

25. A file storing and playing method, comprising steps of:
storing a plurality of data files in a memory of a portable file-playing control device in a manner that starting bytes of said data files are respectively stored at starting positions of different sectors of said memory; and
communicating said portable file-playing control device with a playing apparatus to have said data files played by said playing apparatus.

26. The file storing and playing method according to claim 25 wherein said plurality of data files are data blocks included in a file folder, and said file folder further includes a file header ahead of said data blocks.

27. The file storing and playing method according to claim 26 wherein filling bytes are optionally provided between said file header and one of said data blocks next to said file header.

28. The file storing and playing method according to claim 26 wherein said file header includes a plurality of indices and optional filling bytes between adjacent two of said indices so that starting bytes of said indices are stored at starting positions of storage units of said memory.

29. The file storing and playing method according to claim 25 wherein filling bytes are optionally provided between adjacent two of said data blocks.
